(19) United States
(12) Patent Application Publication
(10) Pub. No.: US 2024/0063906 A1
(43) Pub. Date: Feb. 22, 2024

(54) WIRELESS COMMUNICATION SYSTEM, BASE STATION CONTROL DEVICE, EVACUATION GUIDANCE METHOD, AND BASE STATION CONTROL PROGRAM

(71) Applicant: NIPPON TELEGRAPH AND TELEPHONE CORPORATION, Tokyo (JP)

(72) Inventors: Ryota SHIINA, Musashino-shi, Tokyo (JP); Toshihito FUJIWARA, Musashino-shi, Tokyo (JP); Shinya TAMAKI, Musashino-shi, Tokyo (JP); Tomohiro TANIGUCHI, Musashino-shi, Tokyo (JP)

(73) Assignee: NIPPON TELEGRAPH AND TELEPHONE CORPORATION, Tokyo (JP)

(21) Appl. No.: 18/270,394

(22) PCT Filed: Jan. 4, 2021
(86) PCT No.: PCT/JP2021/000022

§ 371 Date: Jun. 29, 2023

(51) Int. Cl. H04B 10/112; H04W 28/02

(52) U.S. Cl. CPC H04B 10/1129; H04W 28/0231

(57) ABSTRACT

An object of the present disclosure is to reduce a system load imbalance between APs and unfairness in communication quality between users subordinate to each AP.

The present disclosure includes: a plurality of radio base stations that perform wireless communication with terminals; a plurality of optical base stations that are arranged in a communication area of at least one of the plurality of radio base stations and transmit, to a terminal by using an optical signal, an optical ID indicating connection information and authentication information for communicating with an available radio base station among the plurality of radio base stations; and a base station control device that collects, from individual radio base stations, communication quality information of the terminals, determines a deviation in the communication quality of the terminals between the plurality of radio base stations, and when the deviation occurs in the communication quality of the terminals between the plurality of radio base stations, causes fewer optical base stations to transmit the optical ID for communicating with the radio base station having the deviation.

### TECHNICAL FIELD

The present invention relates to a communication control method in wireless communication.

### BACKGROUND ART

In existing wireless LAN systems, a connection control method based on a received signal strength indicator (RSSI) is used. The method based on the RSSI is a manner of connecting to an access point (hereinafter, it may be referred to as an AP) having the highest RSSI. In the conventional method based on the RSSI, when the distribution of terminals is biased, access is concentrated on one AP. When the access is concentrated on one AP, throughput of terminals subordinate to the access point decreases according to the number of connected terminals. As a result, a system load imbalance occurs between the APs.

### CITATION LIST

### Non Patent Literature

Non Patent Literature 1: Ryota Shiina et al., “Application of optical wireless to control plane in optical/RF hybrid wireless system”, in Proceedings of the IEICE Society Conference, B-8-19, September 2019

### SUMMARY OF INVENTION

### Technical Problem

An object of the present disclosure is to reduce a system load imbalance between APs and unfairness in communication quality between users subordinate to each AP.

### Solution to Problem

Specifically, a wireless communication system according to the present disclosure includes:
a plurality of radio base stations that perform wireless communication with terminals;
a plurality of optical base stations that are arranged in a communication area of at least one of the plurality of radio base stations and transmit, to a terminal by using an optical signal, an optical ID indicating connection information and authentication information for communicating with an available radio base station among the plurality of radio base stations; and
a base station control device that collects, from individual radio base stations, communication quality information of the terminals performing wireless communication with the plurality of radio base stations, determines a deviation in the communication quality of the terminals between the plurality of radio base stations, and when the deviation occurs in the communication quality of the terminals between the plurality of radio base stations, causes fewer optical base stations to transmit the optical ID for communicating with the radio base station having the deviation.

Specifically, a wireless communication method according to the present disclosure
is a wireless communication method executed by a wireless communication system in which a plurality of radio base stations and a plurality of optical base stations are connected to a base station control device, in which
the base station control device
collects, from individual radio base stations, communication quality information of terminals that perform wireless communication with the plurality of radio base stations;
determines a deviation in the communication quality of the terminals between the plurality of radio base stations by using the collected communication quality information of the terminals;
when the deviation occurs in the communication quality of the terminals between the plurality of radio base stations, causes fewer optical base stations to transmit an optical ID for communicating with the radio base station having the deviation; and
notifies the plurality of optical base stations of the optical ID to be transmitted to the terminals,
the plurality of optical base stations transmit the optical ID notified from the base station control device to the terminals by using an optical signal, and
any one of the plurality of radio base stations receives connection information and authentication information corresponding to the optical ID from a terminal, and performs wireless communication with the terminal using the received connection information and authentication information.

Specifically, a base station control device according to the present disclosure
is connected to a plurality of radio base stations and a plurality of optical base stations;
causes each optical base station to transmit an optical ID indicating connection information and authentication information for communicating with an available radio base station among the plurality of radio base stations;
collects, from individual radio base stations, communication quality information of terminals that perform wireless communication with the plurality of radio base stations;
determines a deviation in the communication quality of the terminals between the plurality of radio base stations by using the collected communication quality information of the terminals; and
when the deviation occurs in the communication quality of the terminals, causes fewer optical base stations to transmit the optical ID of a radio base station in which the communication is concentrated among the plurality of radio base stations.

Specifically, a base station control program according to the present disclosure is a program for causing a computer to implement each functional unit included in the base station control device according to the present disclosure, and is a program for causing the computer to execute each step included in the wireless communication method according to the present disclosure.

### Advantageous Effects of Invention

According to the present disclosure, it is possible to reduce the system load imbalance between APs and the unfairness in the communication quality between users subordinate to each AP.

### BRIEF DESCRIPTION OF DRAWINGS

FIG. 1 illustrates a basic configuration of a system according to the present disclosure.

FIG. 2 illustrates a deployment example of optical cells.

FIG. 3 illustrates a first example of a system operation flow.

FIG. 4 illustrates a first control example of the optical cells.

FIG. 5 illustrates a second control example of the optical cells.

FIG. 6 illustrates a second example of the system operation flow.

### DESCRIPTION OF EMBODIMENTS

The following describes an embodiment of the present disclosure in detail with reference to the drawings. Note that the present disclosure is not limited to the embodiment described below. Such embodiment is merely an example, and the present disclosure can be carried out in forms with various modifications and improvements based on the knowledge of a person skilled in the art. In addition, constituents having the same reference signs in the present description and the drawings indicate the same constituents.

(Overall System Configuration)

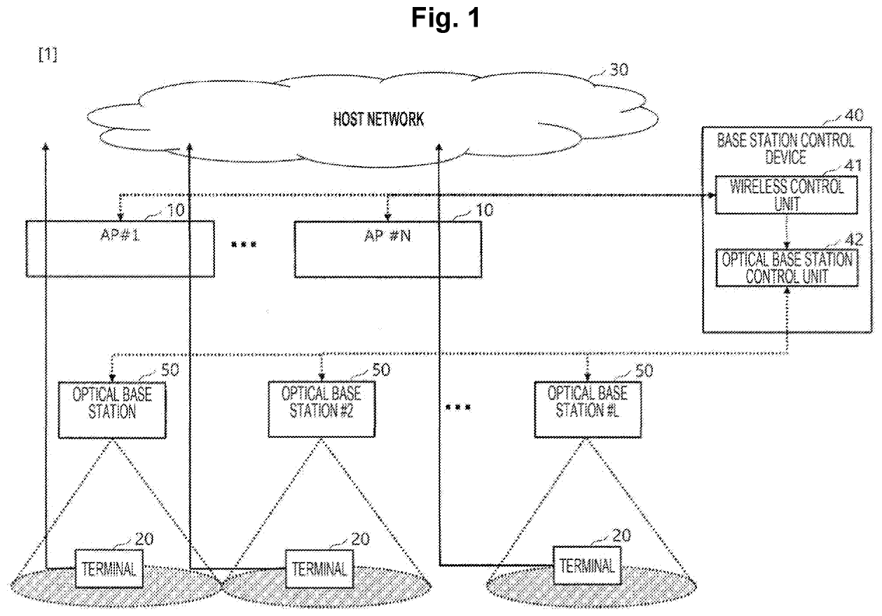

FIG. 1 illustrates a system configuration example according to the present disclosure. The system according to the present disclosure includes a base station control device 40, APs 10 that function as radio base stations such as radio frequency (RF) base stations, and optical base stations 50. The APs 10 are connected to the base station control device 40 and a host network 30. These connection forms are arbitrary, and may be wired connection or wireless connection.

The AP 10 is a device that performs wireless communication with a terminal 20.

The base station control device 40 is a device that externally controls the optical base station 50.

The optical base station 50 is a device that transmits an optical ID notified from the base station control device 40 to the terminal 20 using an optical signal.

The terminal 20 is a device that performs wireless communication with the AP 10 using the received optical ID.

The base station control device 40 includes a wireless control unit 41 and an optical base station control unit 42.

The wireless control unit 41 collects radio base station information from the APs 10, and selects the AP 10 to which the terminal 20 is to be connected.

The optical base station control unit 42 extracts the optical ID corresponding to the AP 10 selected by the wireless control unit 41 from an optical ID list, and notifies the optical base station 50 of the extracted optical ID. Here, the optical ID list includes an optical ID for each AP 10, and may include connection information and authentication information for RF transmission/reception for each AP 10. The connection information is, for example, a service set identifier (SSID). The authentication information is, for example, a password.

The base station control device 40 of the present disclosure can also be realized by a computer and a program, and the program can be recorded in a recording medium or provided through a network.

The optical ID notified from the optical base station control unit 42 to the optical base station 50 may be the optical ID itself, or may be a signal pattern corresponding to the optical ID. The signal pattern includes bit patterns such as 8 bits and 16 bits. Longer bit patterns can improve reception accuracy in the terminal 20.

Any device capable of transmitting the optical signal to the terminal 20 can be used as the optical base station 50, and for example, even a non-communication device that is not originally used for communication applications such as smart lighting can be used. The optical signal transmitted from the optical base station 50 may be modulated by an orthogonal code or the like so as to improve the reception accuracy in the terminal 20.

The terminal 20 has the same optical ID correspondence list as the base station control device 40 has. When receiving the optical ID, the terminal 20 refers to the optical ID correspondence list, and transmits an authentication request to the appropriate AP 10 using the connection information and the authentication information for the RF transmission/reception corresponding to the received optical ID. This enables communication connection between the AP 10 and the terminal 20.

Note that the terminal 20 may not have the same optical ID correspondence list as the base station control device 40 has. For example, the terminal 20 automatically acquires position information from the terminal 20 when an application is activated, and acquires the optical ID correspondence list corresponding to the position information using the application. Furthermore, the terminal 20 may acquire an appropriate optical ID correspondence list corresponding to the position information from a cloud via mobile communication.

The system of the present disclosure performs connection/authentication control of RF communication of the terminal 20 by using the optical ID transmitted from the optical base station 50.

The base station control device 40 centrally controls the APs 10 to which the terminals 20 subordinate to the optical base stations 50 are connected, based on a communication quality index (an average throughput or the like) of the terminals 20 in the respective APs 10.

Here, positions of the optical base stations 50 are known. Therefore, the system of the present disclosure uses physical deployment position information of the optical base stations 50 and the APs 10 to control connection destinations of the terminals 20 subordinate to the optical base stations 50 without acquiring the position information of the terminals 20.

The system of the present disclosure uses, as the optical base station 50, Internet of Things (IoT) type smart lighting or the like that has already been installed. The AP 10 performs a connection/authentication control of RF communication by using the optical signal transmitted from the optical base station 50. By providing the base station control device 40 in the network including the optical base stations 50 and the APs 10, information aggregation from the APs 10 and a management/control of the optical base stations 50 are integrally executed. Through the above operation, the terminals 20 subordinate to the optical base stations 50 are centrally controlled to be connected to the APs 10.

Specifically, communication with a plurality of APs 10 may be possible in an optical cell that can transmit the optical ID from the optical base station 50. The present disclosure adjusts the number of terminals 20 that perform wireless communication with each AP 10 by changing the optical ID transmitted from such optical base station 50. As a result, in the present disclosure, in a case where a deviation occurs in the communication quality between the APs 10, the number of optical base stations 50 that transmit the optical ID of the AP 10 having the deviation is reduced, and the imbalance between the APs 10 is reduced.

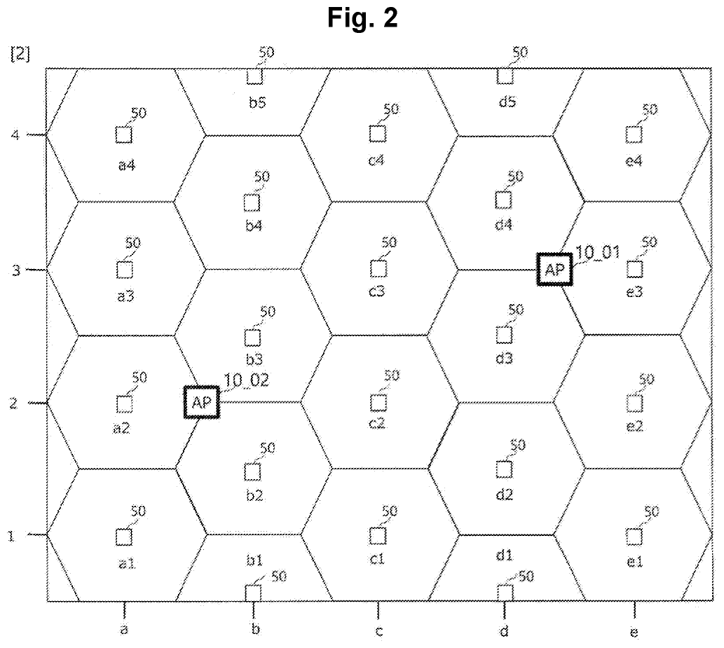

FIG. 2 illustrates a deployment example of the optical cells in which the optical base stations 50 can transmit the optical ID. An example in which an area where AP10_01 and AP10_02 can communicate is divided into optical cells a1 to a4, b1 to b5, c1 to c4, d1 to d5, and e1 to e4 is described. The optical cells (k, j) where “k=a to e” and “j=1 to 5” indicate regions in which the optical base station 50 disposed in each optical cell can transmit the optical ID to the terminals 20. In this way, in the present disclosure, a space covered by the AP 10 is divided into the optical cells that are smaller than a cell of the AP 10. For each optical cell, it is determined to which AP 10 the terminals 20 are to be connected. This will be described below in more detail.

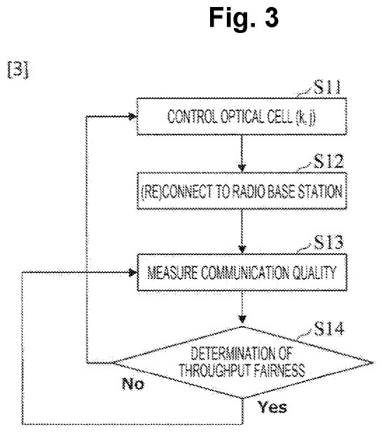

FIG. 3 illustrates a first example of a system operation flow.

S11: The wireless control unit 41 controls the optical ID transmitted from the optical cell according to a predetermined algorithm, and transmits the optical ID to the subordinate terminal 20. An algorithm will be described later.

S12: The terminal 20 receives the authentication information and the connection information by using the received optical ID, and connects to the designated AP 10.

S13: The wireless control unit 41 measures the average throughput per terminal 20 in each AP 10 by using the radio base station information acquired from each AP 10.

S14: When a difference exceeding a certain level occurs between the APs 10 regarding the average throughput per terminal 20 in each AP 10, the wireless control unit 41 determines that it is unfair and controls the optical cell (k, j) again. Here, an example of using the throughput is described in the present embodiment, but the present disclosure can use an arbitrary communication index capable of evaluating the communication quality of the terminal 20 such as a round trip time (RTT) instead of the throughput or together with the throughput. In a case where a difference exceeding a certain level does not occur, it is regarded as fair, and the current connection state of the terminal 20 is maintained.

The wireless control unit 41 may execute the measurement of the communication quality (S13) at an arbitrary time interval or continuously perform the measurement. The wireless control unit 41 executes fairness determination S14 every time the communication quality is measured.

The radio base station information includes the communication quality information of the terminal 20 connected to each AP. The communication quality information is arbitrary information that can determine the communication quality of the terminal 20, and for example, the throughput can be exemplified. The communication quality information may be the average throughput of the terminals 20 communicating with the APs 10 calculated for each AP 10 so that the fairness between the terminals 20 connected to the corresponding APs 10 can be evaluated.

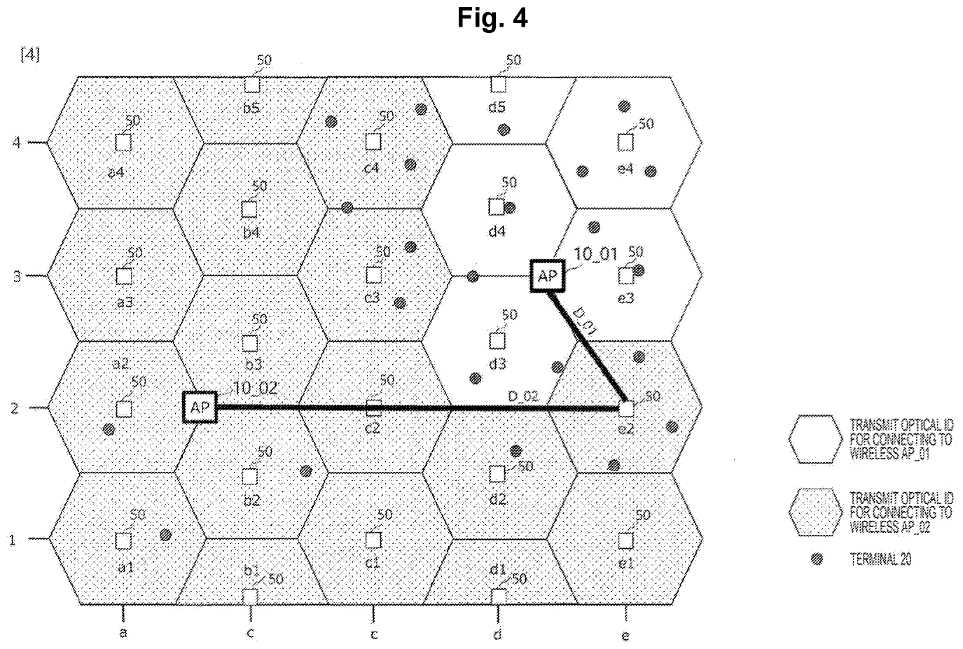

For example, in a case where T₀₁ is the average throughput of the terminals 20 subordinate to AP_01, T₀₂ is the average throughput of the terminals 20 subordinate to AP10_02, α is a set allowable value for a throughput difference, and T₀₂<T₀₁ and (T₀₁−T₀₂)>α, an arbitrary optical cell subordinate to the AP10_02 is to be assigned to the AP10_01 as illustrated in FIG. 4. For example, the optical cell e2, which is subordinate to the AP10_02, closest to the AP10_01, and farthest from the AP10_02, is to be assigned to the AP10_01. In this case, the optical base station 50 of the optical cell e2 transmits the optical ID for communicating with the AP10_01 to the terminals 20.

On the other hand, when T₀₂>T₀₁ and (T₀₂−T₀₁)>α, one of the optical cells subordinate to AP10_01 is to be assigned to AP10_02 as illustrated in FIG. 4. For example, the optical cell d3, which is subordinate to the AP10_01, closest to the AP10_02, and farthest from the AP10_01, is to be assigned to the AP10_02. In this case, the optical base station 50 of the optical cell d3 transmits the optical ID for communicating with the AP10_02 to the terminals 20.

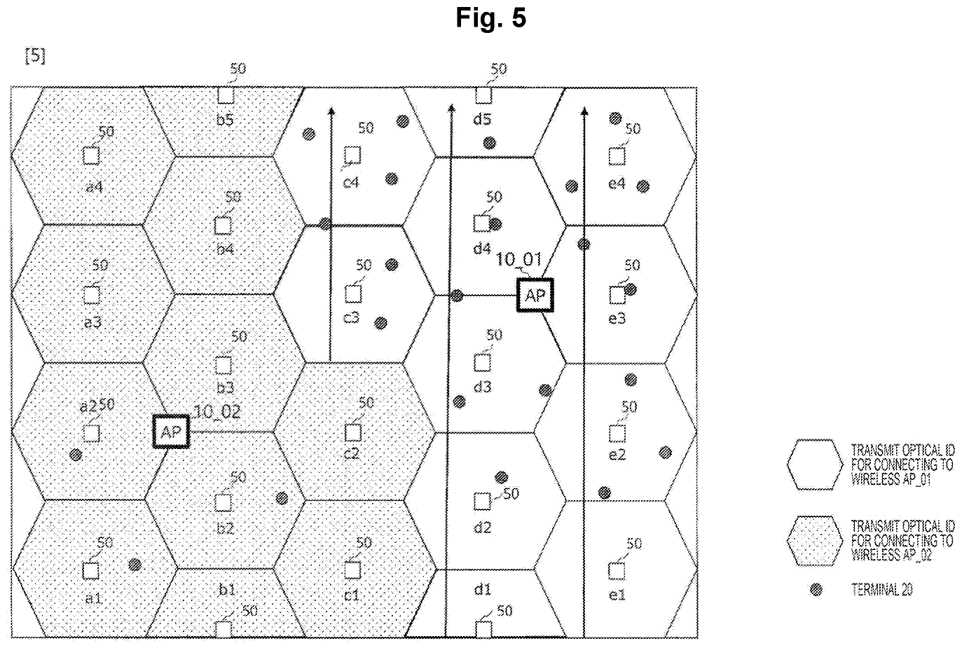

Here, the optical cell that is caused to change the AP 10 to which it is assigned is not restricted by a positional relationship with the APs 10_01 and 10_02. For example, when T₀₂>T₀₁ and (T₀₂−T₀₁)>α, as illustrated in FIG. 5, the wireless control unit 41 may change the AP 10 to which the optical cells are assigned, to the AP10_01 in a scanning line manner in an order of the optical cell c3, the optical cell c4, the optical cell d1, and the optical cell d2, and may stop the process when (T₀₂−T₀₁)≤0 or (T₀₂−T₀₁)≤α is satisfied.

Note that, in step S13, the wireless control unit 41 may use an index representing the communication quality instead of the throughput without directly measuring the throughput. In addition, the number of APs 10 may be 3 or more. In this case, the throughput difference between the radio base station having the maximum average throughput and the radio base station having the minimum average throughput is obtained, and the number of optical base stations transmitting the optical ID for communicating with the radio base station having the maximum average throughput may be reduced.

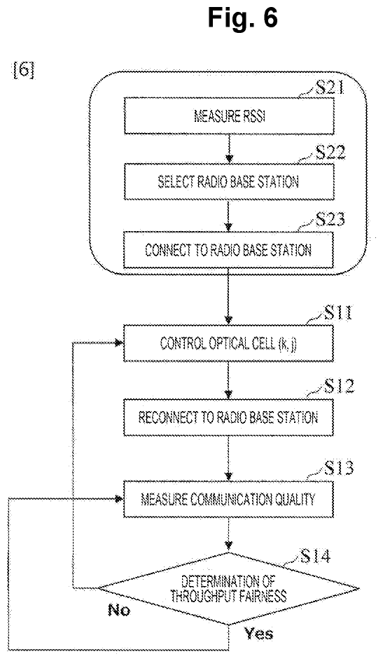

FIG. 6 illustrates a second example of the system operation flow. In the second example, when the terminal 20 is not subordinate to the optical cell, the present disclosure executes steps S21 to S23 before steps S11 to S13.

S21: The individual terminal 20 collects RSSI information.

S22: The AP 10 having a large RSSI is selected based on determination of the individual terminal 20.

S23: Connection negotiation is performed and the AP 10 having a large RSSI is connected.

When the terminal 20 moves to be subordinate to the optical cell, the present disclosure executes steps S11 to S13.

When the optical cells cannot cover an entire coverage area of the wireless LAN, a normal RSSI connection according to the prior art is performed during an initial connection, and the terminal 20 is connected to the wireless LAN. Then, when the terminal 20 moves to be subordinate to the optical cell, the terminal 20 is connected to the optimal AP 10 via the optical ID. As a result, even when there is an area that the optical cells cannot cover in the coverage area of the wireless LAN, the initial connection of the terminal 20 can be performed in the area.

### Effects

As described above, the present disclosure relates to
a wireless communication system that has a plurality of RF base stations, a plurality of optical base stations, the number of which is greater than the RF base stations, and a base station control device, and that performs connection and authentication control between a terminal and the RF base station by using an optical ID transmitted from the optical base station in an optical cell covered by the optical base station.

The RF base stations and the optical base stations are arranged so that each RF cell covered by each RF base station is divided into a plurality or optical cells covered by individual optical base stations.

The base station control device determines the RF base station to which a terminal in each optical cell is to be connected based on the communication quality of the individual terminal connected to each RF base station, and performs control to transmit the optical ID for connecting to the determined RF base station to the optical base station corresponding to the optical cell.

Thereby, according to the present disclosure, even in a case where distribution of users is biased in a wireless area in which a plurality of APs exist, it is possible to ensure the fairness of the system load between the APs and communication quality between users subordinate to each AP from the perspective of the entire system. Furthermore, the present disclosure can realize the above even in a case where detailed position information of the users cannot be obtained.

### INDUSTRIAL APPLICABILITY

The present disclosure can be applied to information and communication industries.

### REFERENCE SIGNS LIST

10 Base station
20 Terminal
21 Optical receiver
23 Optical ID analysis circuit
24 Terminal side RF transmitter
30 Host network
40 Base station control device
41 Wireless control unit
42 Optical base station control unit
50 Optical base station

1. A wireless communication system comprising:
a plurality of radio base stations that perform wireless communication with terminals;
a plurality of optical base stations that are arranged in a communication area of at least one of the plurality of radio base stations and transmit, to a terminal by using an optical signal, an optical ID indicating connection information and authentication information for communicating with an available radio base station among the plurality of radio base stations; and
a base station control device that collects, from individual radio base stations, communication quality information of the terminals performing wireless communication with the plurality of radio base stations, determines a deviation in the communication quality of the terminals between the plurality of radio base stations, and when the deviation occurs in the communication quality of the terminals between the plurality of radio base stations, causes fewer optical base stations to transmit the optical ID for communicating with the radio base station having the deviation.

2. The wireless communication system according to claim 1, wherein
the communication quality is average throughput of the terminal communicating with each radio base station, and
when a difference exceeding a set value in the average throughput occurs between the plurality of radio base stations, the base station control device causes fewer optical base stations to transmit the optical ID for communicating with the radio base station having the maximum average throughput.

3. The wireless communication system according to claim 1, wherein
the base station control device changes the optical ID of the optical base station farthest from the radio base station with bias, among the optical base stations transmitting the optical ID of the radio base station, to the optical ID of another radio base station, different from the radio base station with bias, among the plurality of radio base stations.

4. A wireless communication method executed by a wireless communication system in which a plurality of radio base stations and a plurality of optical base stations are connected to a base station control device, wherein
the base station control device
collects, from individual radio base stations, communication quality information of terminals that perform wireless communication with the plurality of radio base stations;
determines a deviation in the communication quality of the terminals between the plurality of radio base stations by using the collected communication quality information of the terminals;
when the deviation occurs in the communication quality of the terminals between the plurality of radio base stations, causes fewer optical base stations to transmit an optical ID for communicating with the radio base station having the deviation; and
notifies the plurality of optical base stations of the optical ID to be transmitted to the terminals,
the plurality of optical base stations transmit the optical ID notified from the base station control device to the terminals by using an optical signal, and
any one of the plurality of radio base stations receives connection information and authentication information corresponding to the optical ID from a terminal, and performs wireless communication with the terminal using the received connection information and authentication information.

5. A base station control device
that is connected to a plurality of radio base stations and a plurality of optical base stations,
causes each optical base station to transmit an optical ID indicating connection information and authentication information for communicating with an available radio base station among the plurality of radio base stations;
collects, from individual radio base stations, communication quality information of terminals that perform wireless communication with the plurality of radio base stations;
determines a deviation in the communication quality of the terminals between the plurality of radio base stations by using the collected communication quality information of the terminals; and
when the deviation occurs in the communication quality of the terminals, causes fewer optical base stations to transmit the optical ID of a radio base station in which the communication is concentrated among the plurality of radio base stations.

6. A non-transitory computer-readable medium having computer-executable instructions that, upon execution of the instructions by a processor of a computer, cause the computer to function as the base station control device according to claim 5.
